(19) United States
(12) Patent Application Publication
(10) Pub. No.: US 2003/0063659 A1
(43) Pub. Date: Apr. 3, 2003

(54) Method and apparatus for adjusting digital filters in a DSL modem

(76) Inventors: Antti Kaltiainen, Espoo (FI); Martin Makundi, Helsinki (FI)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/969,150

(22) Filed: Oct. 3, 2001

(51) Int. Cl. H04B 1/38; H04L 5/16

(52) U.S. Cl. 375/222

(57) ABSTRACT

The present invention relates to DSL modems, and the tunability of digital filters in DSL modems. The tunability of digital filters in DSL modems are provided by a signal processing unit in a DSL (Digital Subscriber Line) modem, which comprises at least one transmit and one receive digital filter that are adjustable through modem control means, input means for receiving a data from a modem chip, output means for transmitting data to the modem chip and means for providing control parameters to at least one transmit and one receive digital filter from the modem control means. The signal processing unit is implemented to DSL modems, apparatus comprising multiple DSL modems and a system for data transmission between a customer premises DSL modem and a DSL device. The present invention further relates to methods of adjusting the digital filters in DSL modems.

### TECHNICAL FIELD OF THE INVENTION

The present invention relates to DSL modems, and more closely, to provide tunability of digital filters in DSL modems.

### BACKGROUND OF THE INVENTION

Twisted-pair copper telephone lines are widely used to transfer both telephone calls and information over the Internet. The most used method for receiving information is a voice grade data modem that has limitations on the capacity it can transmit. Voice grade modems presently transmit up to 33.6 kbps over a common telephone line. Reasons for success of the voice grade data modems are that they can be connected immediately anywhere a telephone line exists and they are essentially cheap to buy. Even though the voice grade data modems can provide an Internet connection, the services they can provide, due to the low transmit speed, are limited. The voice grade data modems are unable to provide e.g., interactive multimedia services or telephone calls at the same time when the voice grade data modems are used for data communications.

Various methods for providing faster data transmission over the existing twisted-pair copper lines have been introduced. The most usual high data rate modems provided for individual subscribers are based on ADSL (Asymmetric Digital Subscriber Line) technology. ADSL modems cost more than voice grade data modems but they also provides faster data transmission. The data transmission speed for the ADSL is 1.5 to 9.0 Mbps for downstream speed and 16 to 640 kbps for upstream speed, i.e., ADSL transmits an asymmetric data stream with much more bandwidth downstream to the subscriber and much less bandwidth upstream from the subscriber. The ADSL technology is designed to overcome the deficiencies of the copper wire technology, so that the system would work as the system, which is fully optical fiber based. In order to speed up the transmission over the copper wire, the ADSL systems need to solve problems based on the copper wire deficiencies such as disturbances and signal conversions. For the foregoing deficiencies, the filtering of the information in the stream is complex and important in order to provide the data as it was received from the server (or alike) in the network. The ADSL solution is enough for plenty of different services, such as video on demand, home shopping, Internet access, remote LAN access, and multimedia access. Even though ADSL is capable of transmitting most of the services wanted by individual users, ADSL is not capable of transmitting e.g., HDTV (High Definition Television) services that demands as much as 20 Mbps data rate. Therefore, ADSL is not suitable for so called full service network.

VDSL (Very high data rate Digital Subscriber Line) modems are designed to fulfill the requirements of the data rate speeds of the full service network. VDSL can provide up to 52 Mbps for downstream and upstream totally. Both asymmetric and symmetric data rates are possible. The data rates are higher than in ADSL systems. Although, VDSL provides higher data rates than ADSL, it provides them over shorter lines. For example, for a downstream data rate of 52 Mbps the wire length is only about 300 meters. Both downstream and upstream channels can be separated in frequency from bands used for both POTS (Plain Old Telephone Service) and ISDN (Integrated Services Digital Network), enabling service providers to overlay VDSL on existing services.

Even though early implementations of VDSL use existing twisted-pair telephone lines, VDSL later on makes use of an alternative solution, which is a combination of fiber cables feeding neighborhood Optical Network Units (ONUs) and last leg premises connections by new or existing copper. This topology is so called Fiber to the Neighborhood (FTTN). Fiber to the Neighborhood encompasses Fiber to the Curb (FTTC) and Fiber to the Basement (FTTB). FTTC is a network where an optical fiber runs from telephone switch to a curbside distribution point close to the subscriber wherein it is converted to a copper pair. The difference between FTTC and FTTB is that when FTTC is implemented with short drops, e.g., houses, FTTB serves tall buildings with vertical drops.

As defined by ADSL Forum, VDSL is simpler than ADSL in many ways, since shorter lines impose far fewer transmission constraints so that the basic transceiver technology is much less complex. On the other hand much higher frequencies used in VDSL set more design challenges to system. Even though VDSL targets to ATM (Asynchronous Transfer Mode) network architectures (or its future correspondences), which will take decades to become ubiquitous, VDSL is asked to transmit conventional circuit and packet switched traffic.

VDSL must transmit compressed video, a real time signal unsuited to error retransmission schemes used in data communications. To achieve error rates compatible with compressed video, VDSL will have to incorporate Forward Error Correction (FEC) with sufficient interleaving to correct all errors created by impulsive noise events of some specified duration.

The following four line codes are proposed for VDSL by ADSL Forum:

CAP (Carrierless amplitude/phase modulation),

DMT (Discrete Multitone), which is a multicarrier system using Discrete Fourier Transforms to create and demodulate individual carriers,

DWMT (Discrete Wavelet Multitone), which is a multicarrier system using Wavelet Transforms to create and demodulate individual carriers, and

SLC (Simple Line Code), which is a version of four-level baseband signaling that filters the based band and restores it at the receiver.

The transmitted and received signals are separated using Frequency Division Multiplexing (FDM). The transmitted and received signals are thus in the different frequency ranges. The frequency range is also called a frequency band. The signals can be limited in certain band using bandpass filters. Filters are devices that let some frequencies go through and stop the other frequencies. Filters can be lowpass, which let through lower frequencies than the filter specific cut-off frequency, highpass, bandpass or bandstop type. In case of bandpass filter there are two cut-off frequencies correspondingly.

There has been proposed various modem solutions for VDSL standards. In the modem solutions presented, one of the problems that exists is that the hardware configuration of VDSL modems is hard wired at the factory. Therefore, improvements in the filter transfer characteristics or changes in frequency plans require a revision of layout designs and a new production round in the factory. Furthermore, the customer cannot decide to change their frequency plans while continuing to use the same hardware.

### SUMMARY OF THE PRESENT INVENTION

It is an object of the present invention to overcome or at least mitigate the disadvantages of the prior art. The present invention provides a solution for tuning (or adjusting) digital filters in the signal processing unit of a DSL modem with the modem control means of the DSL modem. The solution is achieved with specified methods and signal processing units as disclosed in the appended claims.

It is an object of the present invention to provide a compact digital solution able to cope with multiple bands. In addition certain embodiments of the invention provides a remote configurability of the filters through the existing network management system.

Further, it is an object of the present invention to provide a signal processing unit, which is implemented in a modem or corresponding equipment, that may be reconfigured according to the changes in the physical characteristics of the subscriber line.

According to a first aspect of the present invention there is provided a signal processing unit in a DSL (Digital Subscriber Line) modem, comprising:

at least one transmit and one receive digital filter that are adjustable through modem control means;

input means for receiving a data from a modem chip;

output means for transmitting data to the modem chip; and

means for providing control parameters to at least one transmit and one receive digital filter from the modem control means.

Preferably, the control parameters are provided via a bus from the modem control means to at least one transmit and one receive digital filter.

Preferably, the signal processing unit is arranged to receive control parameters provided by the modem control means, which is a personal computer (PC) or a network element manager (NEM).

Preferably, the signal processing unit further comprises a digital to analog converter for converting a digital data into an analog data and an analog to digital converter for converting an analog data into a digital data.

Preferably, the signal processing unit further comprises means for adjusting a digital signal level. More preferably, the means for adjusting a digital signal level is an automatic gain control (AGC) circuit.

According to a second aspect of the present invention there is provided a method for adjusting digital filters of a signal processing unit in a DSL (Digital Subscriber Line) modem, comprising steps of:

connecting a DSL modem into a counterpart DSL device;

testing a connection between the DSL modem and the counterpart DSL device;

providing modem control information from modem control means to the signal processing unit of the DSL modem; and

tuning at least one digital filter in the signal processing unit of the DSL modem according to the modem control information received from the modem control means.

Preferably, the modem control information is provided through a bus connecting the signal processing unit of the DSL modem and the modem control means.

Preferably, the modem control information is a standard bandplan for VDSL modems, wherein the standard bandplan is one of the following: Plan 997 and 998 as defined in ETSI and ANSI standards.

Preferably, the method further comprises a step of downloading a new configuration file or a modem control software from a specified host upon notification.

Preferably, the method further comprises a step of receiving in the modem control means a new configuration file or a modem control software from a specified host.

Preferably, the method further comprises a step of changing new configuration parameters or reading new configuration parameters from a configuration file in the modem control means.

Preferably, the method further comprises a step of providing from the modem control means the configuration parameters, i.e., the modem control information, to digital filters in the signal processing unit of the DSL modem. More preferably, the configuration parameters can be changed in the modem control means by interpolation or by changing the configuration parameters into configuration parameters according to a specified plan.

Preferably, the modem control means transmit configuration information to both digital filters and a modem chip essentially at the same time.

Preferably, the configuring information is changed according to the change in physical characteristics of the subscriber line.

According to a third aspect of the present invention there is provided a DSL (Digital Subscriber Line) modem for data receiving and transmitting, comprising:

signal processing unit having at least one transmit and one receive digital filter that are adjustable through modem control means, input means for receiving a data from a modem chip, output means for transmitting data to the modem chip, and means for providing control parameters to at least one transmit and one receive digital filter from the modem control means;

a digital to analog converter for converting a digital data into an analog data;

an analog to digital converter for converting an analog data into a digital data;

a modem circuit, which is configurable through the modem control means;

an analog anti-image filter for adjusting the maximum frequency of the outgoing signal;

an analog anti-alias filter for adjusting the maximum frequency of the incoming signal; and

a circuitry for transforming between two-line and four-line topologies.

Preferably, the DSL modem is connected to the modem control means through a bus.

Preferably, the modem control means is a personal computer (PC) or a network element manager (NEM).

Preferably, the DSL modem further comprises means for adjusting a signal level, wherein the means for adjusting the signal level is an automatic gain control (AGC) circuit.

Preferably, the signal processing unit is a FPGA (Field Programmable Gate Array) chip or an ASIC (Application Specific Integrated Circuit) chip.

According to a fourth aspect of the present invention there is provided an apparatus comprising:

multiple DSL (Digital Subscriber Line) modems, the apparatus comprising: multiple DSL modems, wherein a DSL modem has at least one signal processing unit having at least one digital filter that are adjustable through modem control means, input means for receiving a data from a modem chip, output means for transmitting data to the modem chip, and means for providing control parameters to at least one transmit and one receive digital filter from the modem control means, the DSL modem further having a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies;

a memory; and

a central processing unit (CPU).

According to a fifth aspect of the present invention there is provided a method for data transmission between a customer premises DSL (Digital Subscriber Line) modem and a DSL device, the method comprising:

connecting the customer premises DSL modem to the DSL device through a subscriber line;

receiving a configuration file or a modem control software from a user defined server to a modem control means of the customer premises DSL modem;

reconfiguring the parameters of the customer premises DSL modem in the modem control means;

transmitting the reconfigured parameters of the customer premises DSL modem from the modem control means through a bus or a line to a signal processing unit of the customer premises DSL modem;

tuning digital filters in the signal processing unit of the customer premises DSL modem according to the parameters reconfigured in the modem control means; and

transmitting data between the customer premises DSL modem and the DSL device.

Preferably, the user defined server is a remote host defined by the DSL device.

Preferably, the method further comprises requesting to download the new configuration file or a modem control software.

According to a sixth aspect of the present invention there is provided a system for data transmission between a customer premises DSL (Digital Subscriber Line) modem and a DSL device, the system comprising:

a customer premises DSL modem having signal processing unit having at least one transmit and one receive digital filter that are adjustable through modem control means, input means for receiving a data from a modem chip, output means for transmitting data to the modem chip, and means for providing control parameters to at least one transmit and one receive digital filter from the modem control means, a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies;

a customer premises DSL modem control means for reconfiguring parameters of the customer premises DSL modem;

a subscriber line between the customer premises DSL modem and the DSL device for data transmission;

a DSL device, the DSL device having signal processing unit having at least one transmit and one receive digital filter that is adjustable through modem control means, input means for receiving a data from a modem chip, output means for transmitting data to the modem chip, and means for providing control parameters to at least one transmit and one receive digital filter from the modem control means, a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies; and

a modem control means of the DSL device for reconfiguring parameters of the DSL device.

Preferably, the system further comprises a remote host, from where the customer premises DSL modem control means requests and downloads a new configuration file or a modem control software in order to reconfigure parameters of the customer premises DSL modem.

According to a seventh aspect of the present invention there is provided means for adjusting digital filters in a DSL (Digital Subscriber Line) modem, the means for adjusting comprising:

means for receiving a configuration file or a modem control software from a host in a network;

means for reconfiguring parameters of a DSL modem; and

means for transmitting the reconfigured parameters to a signal processing unit of the VDSL modem.

Preferably, means for receiving request to download the configuration file or the modem control software from a remote host upon notification.

According to a eigth aspect of the present invention there is provided a method for adjusting digital filters in a DSL (Digital Subscriber Line) modem, the method comprising:

receiving a configuration file or a modem control software conforming parameters of a counterpart DSL modem in modem control means of the DSL modem;

reconfiguring parameters of the DSL modem in the modem control means;

transmitting the reconfigured parameters to a signal processing unit of the DSL modem; and

tuning digital filters in the signal processing unit of the DSL modem.

Preferably, the method further comprises requesting to download the new configuration file or a modem control software upon notification.

The digital filter implementation allows tunability, and further offers superb component and temperature tolerance behavior when compared to bulk analog components. Lower complexity of the analog front-end anti-image and anti-alias filters required for high frequency D/A (Digital to Analog) and A/D (Analog to Digital) interfaces compared to prior art solutions, which means lower component count and cost and requires less footprint in the circuit board than in prior art solutions.

Also, the tunability of the digital filters enables employment of extended frequency bands and sets optional profiles. The optional profiles offer far more applications and services because the upstream and downstream data rates can be modified flexibly. In present invention it is possible using the same hardware.

In case of in-band disturbers, it may be impossible to get a viable link up. In-band disturbances such as Radio Frequency Ingress (RFI) and cross-talkers can be filtered, while using a narrower transmission band than allowed.

### BRIEF DESCRIPTION OF THE DRAWINGS

For a better understanding of the present invention and in order to show how the same may be carried into effect reference will now be made to the accompanying drawings, in which:

FIG. 1 shows a general presentation of a network implementing VDSL principles.

FIG. 2 shows a system for connection between a PC (Personal Computer) and a network or a video server.

FIG. 3 shows a frequency band allocation plan 998 for asymmetric capabilities according to a regional plan in Europe.

FIG. 4 shows a preferred embodiment of the present invention.

FIG. 5 is a flowchart illustrating the method of the preferred embodiment of the present invention.

### DETAILED DESCRIPTION OF CERTAIN EMBODIMENTS

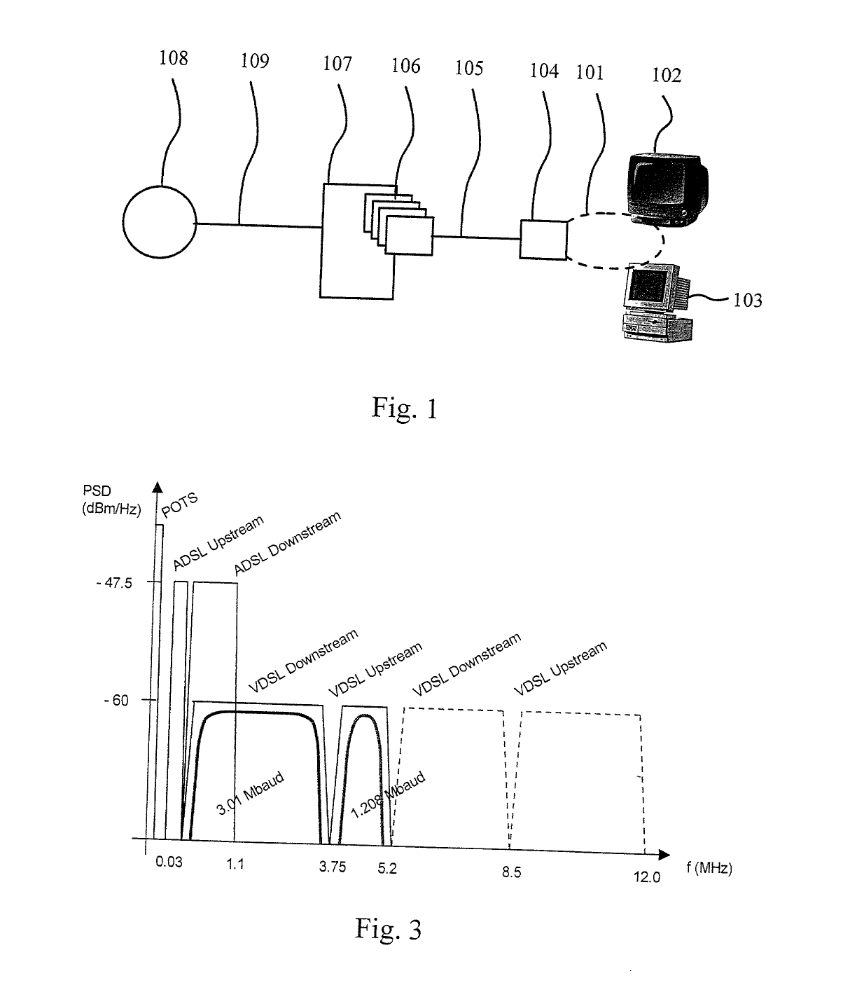

FIG. 1 shows a general presentation of a network implementing VDSL principles. In FIG. 1, there is shown a premises distribution network 101 comprising a television 102 and a PC (Personal Computer) 103. The premises distribution network 101 is connected to a customer premises VDSL modem 104, which provides the transformation of data from a digital form to an analog form and vice versa, located in the premises.

The customer premises VDSL modem 104 is connected through a twisted-pair copper telephone line 105 to one of VDSL modems 106 in an Optical Network Unit (ONU) 107, which ONU VDSL modem 106 converts the analog signal, coming from the customer premises VDSL modem 104 through the twisted-pair copper telephone line 105, into the digital form, and from the digital signal, that is going to the customer premises VDSL modem 104, into the analog form. ONU 107 has several VDSL modems 106 to collect the traffic coming from different VDSL users, each having VDSL modem 104.

Downstream, i.e., a data stream from the ONU VDSL modem 106 to the customer premises VDSL modem 104, and upstream, i.e., a data stream from the customer premises VDSL modem 104 to the ONU VDSL modem 106, is totally 52 Mbps in the best case, depending on the twisted-pair copper telephone wire length.

The ONU 107 is connected to a core network 108 through a fiber cable 109, having an optical connection with considerably faster data rate than the twisted-pair copper telephone line. The optical connection between the core network 108 and the ONU 107 may be implemented according to different possibilities defined in SDH (Synchronous Digital Hierarchy) standards, and in the future in DWDM (Dense Wavelength Division Multiplexing) standards.

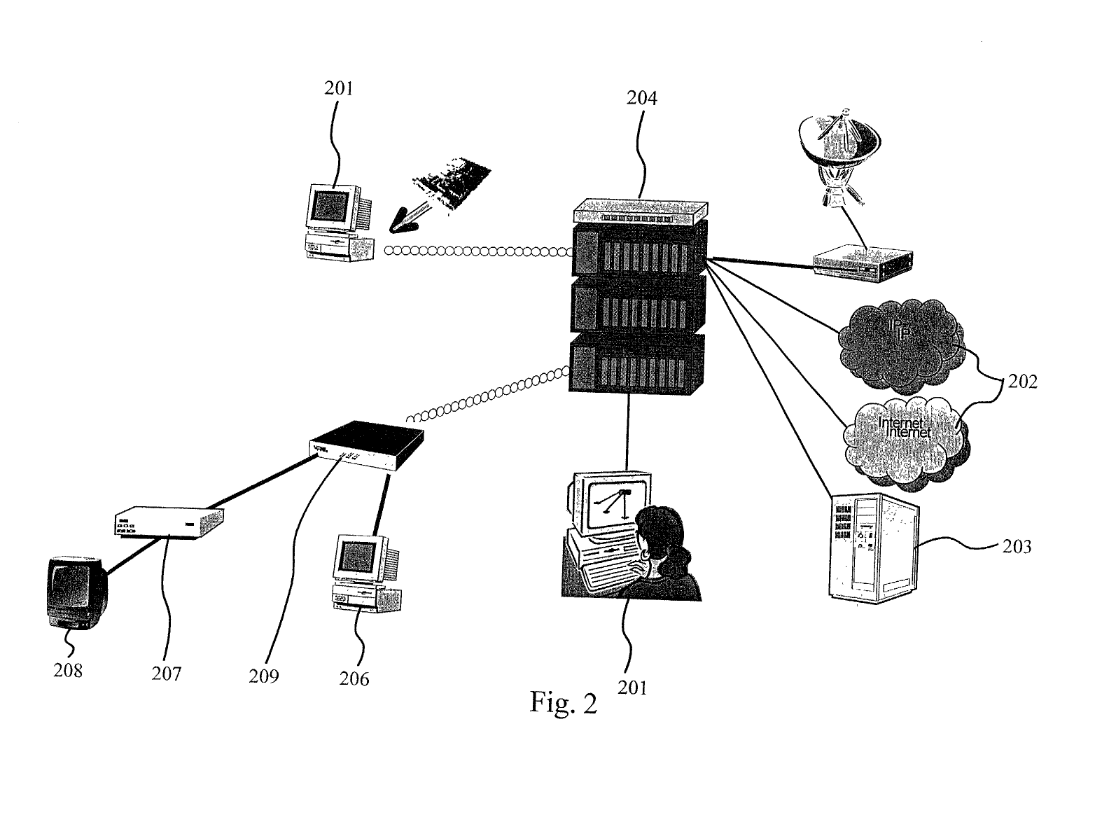

FIG. 2 shows a system for connection between a PC (Personal Computer) and a network or a video server. The PC may also be defined as customer premises equipment. In FIG. 2, the connection from the PC (Personal Computer) 201 to the network (Internet Protocol (IP) network or Internet network) 202 or to the video server 203 can be implemented by the present invention. The PC 201 has a VDSL modem card in itself, which is able to convert the data stream from a digital form into an analog form when the user of the PC e.g., requests a video feed (or alike) from a video server. The VDSL modem card is also capable of converting the video stream coming from the video server 203 from the analog form into the digital form.

The PC 201 is connected through a subscriber line to a DSLAM (Digital Subscriber Line Access Multiplexer) 204, which concentrates several single subscriber lines into a single ATM line (or alike), i.e., the DSLAM 204 provides data channel multiplexing and network interconnection for many DSL access lines. The DSLAM 204 includes several modem cards to terminate DSL data channels, along with connections into an ATM (or alike) data network or to other data transmission services, such as trunk lines and Ethernet. The DSLAM comprises e.g., several modem cards, a CPU (Central Processing Unit), a memory and several busses for enabling interworking of different parts of the DSLAM 204.

The DSLAM 204 is further connected to the network 202 and to the video server 203, wherefrom the DSLAM 204 receives the data that is further transmitted to the customer premises equipment and whereto the DSLAM 204 transmits requests to receive certain information requested by the user of the customer premises equipment. The request for information received from the customer premises equipment is received in an analog form, which data is thereafter converted into a digital form and filtered in the DSLAM 204, and further transmitted to the network 202 or to the video server 203. The data received from the network 202 or from a video server 203 is received through a fiber cable to the DSLAM 204, which thereafter converts the received data from the digital format into an analog format and retransmits the data to the customer premises equipment through the subscriber line.

A Network Element Manager (NEM) 205 can configure and control the network element like DSLAM 204. The Network Element Manager 205 also measures the connection between the customer premises equipment (e.g., the PC 201) and the DSLAM 204.

According to the present invention, in case the Network Element Manager 205 measures that the DSLAM 204 and the customer premises equipment use different bandwidth allocation, the Network Element Manager 205 may send a notification to the customer premises equipment to download from a specific host a new configuration file or a modem control software in order to change or modify the parameters of the customer premises DSL modem to correspond to the parameters of the DSLAM DSL modem. Alternatively, the Network Element Manager 205 may provide a new configuration file to the DSLAM DSL modem in order to bring the parameters of the DSLAM DSL modem to correspond to the customer premises DSL modem or to the bandwidth allocation used in the transmission between the DSLAM 204 and an equipment in the network 202 or the video server 203.

After receiving the notification to download the new configuration file or the modem control software from the specific host to the customer premises equipment, the customer premises equipment sends a request to download the new configuration file or the modem control software from the specified host. The specified host may be e.g., the Network Element Manager 205 or a server in the network 202. The specified host sends the new configuration file or the modem control software to the customer premises equipment. The modem control means thereafter processes the received data so that the parameters of the DSL modem of the customer premises equipment may be changed or modified to correspond to the parameters of the DSL modem in the DSLAM 204.

The new parameters may be loaded to the memory of the customer premises equipment, wherefrom the parameters may be loaded to a signal processing unit of the DSL modem of the customer premises equipment. There may also be new parameters to a modem chip of the DSL modem in the received new configuration file or the modem control software that may be processed so that the modem control means transmits new or modified parameters to the modem chip essentially at the same time than the modem control means transmits the new or modified parameters to the signal processing unit of the DSL modem.

The reasons for measuring different characteristics between the customer premises DSL modem and the DSLAM DSL modem may vary. For example, new customer premises equipment is connected to the DSLAM and the hardware configuration of the DSL modem is still in the factory settings, which differs from the settings of the DSLAM DSL modem. Further, the reason may be that the physical characteristics of the subscriber line between the customer premises equipment and the DSLAM are changed, e.g., the length of the subscriber line has been changed. Further, there may be some in-band disturbers that were not present in earlier connections.

Alternative connection between a user and the network 202 or the video server 203 is also shown in the FIG. 2. In this alternative solution a PC 206 and a set-top-box 207 of a television 208 are connected to a router 209, which further is connected to the DSLAM 204 through a subscriber line. The subscriber line between the router 209 and the DSLAM 204 is a twisted-pair copper line. The connection between the DSLAM 204 and the network 202 or the video server 203 is fiber cable. This solution enables e.g., the user to connect him/her to the video server 203 to request certain movie(s) or program(s).

According to the present invention, it is also possible to reconfigure the parameters of the DSL modem in the router 209 in the same manner as were presented with respect to the reconfiguring the parameters of the DSL modem in the customer premises equipment.

FIG. 3 shows in exemplifying manner one possible frequency profile plan that may be used in the present invention. In a VDSL standard, there are several frequency profile plans for different business areas. The upstream and downstream QAM/DMT (Quadrature Amplitude Modulation/Discrete Multitone) signals are transmitted in specific slots defined by the profile.

One profile, i.e., a frequency band allocation plan 998 for asymmetric capabilities according to a regional plan in Europe, is shown in FIG. 3. From FIG. 3 can be seen that the frequencies for upstream and downstream for VDSL are separated from the frequencies used for POTS (Plain Old Telephone Services), i.e., frequencies up to 3.4 kHz. In the exemplary frequency band allocation shown in FIG. 3, the VDSL system is using frequencies starting from about 0.138 MHZ up to about 12 MHz.

Alternative frequency profile plans are e.g., plan 997 for symmetric and asymmetric capabilities to a standard plan for Europe or asymmetric for specially for streaming video or symmetric for achieving maximum symmetrical speed.

Even though there is shown some examples of the frequency plans that may be used in the implementation of the present invention, the man skilled in the art realizes that many other frequency plans may be used without departing from the scope of the present invention.

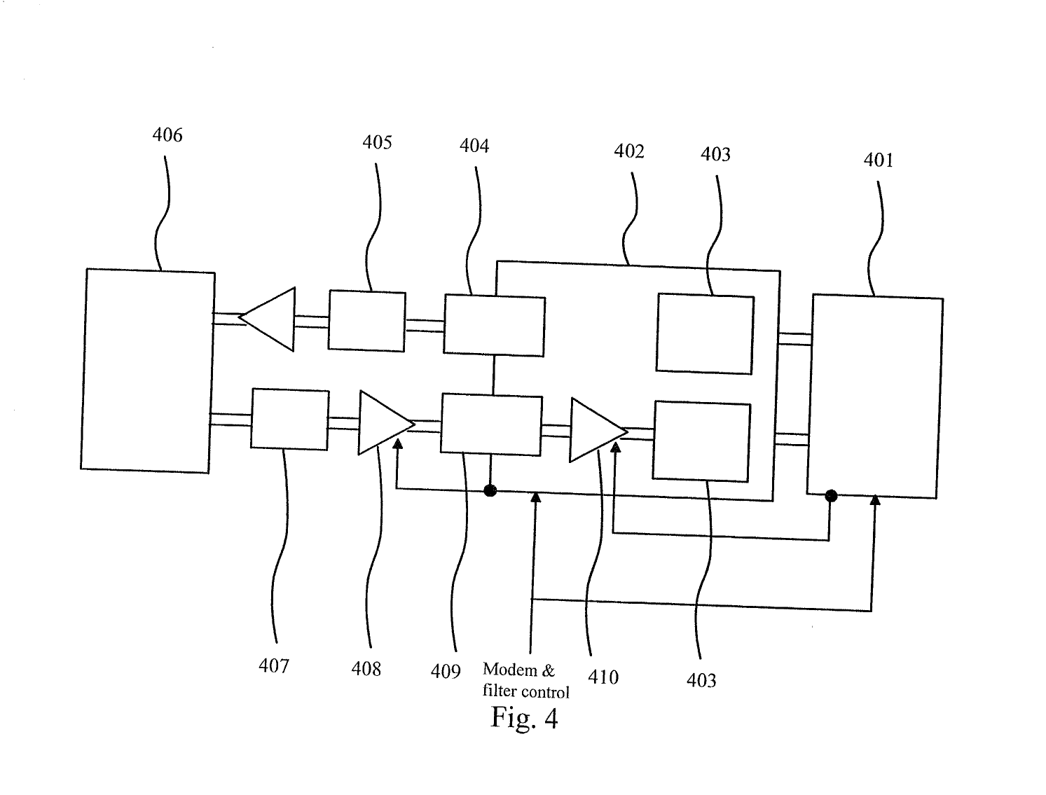

FIG. 4 shows a preferred embodiment of the present invention. In FIG. 4, there is shown a connection between a modem chip 401 and a signal processing unit 402. The connection between the modem chip 401 and the signal processing unit 402 is implemented with a four-wire topology, i.e., two wires (i.e., a wire pair) are reserved for outgoing data and two wires are reserved for incoming data. In this presentation the outgoing data is data that is transmitted from a VDSL modem of a PC (or alike) to a network, and the incoming data is data that is received from the network to the VDSL modem of the PC (or alike).

When transmitting data from the PC (or alike) to the network, the data is provided from the modem chip 401 to the signal processing unit 402, which can be a FPGA (Field Programmable Gate Array) chip or an ASIC (Application Specific Integrated Circuit) chip. The signal processing unit 402 comprises tunable digital filters 403 for both outgoing and incoming data. The outgoing data is filtered according to the desired transmission profile (for example FIG. 3) by using tunable filters. The advance is in the tunability, because transmission profile can be chosen in the present invention.

Thereafter, the outgoing data is forwarded to a transmit digital to analog (D/A) converter 404, which converts the digital signal into the analog signal. The D/A converter can be implemented into the signal processing unit 402 or it may be located outside the signal processing unit 402.

From the D/A converter 404, the analog signal is directed to an analog anti-image filter 405, which is used to suppress image frequencies produced in the D/A conversion process. From the analog anti-image filter 405, the data is forwarded to a hybrid circuitry 406, which converts between four-wire and two-wire topologies. The data is sent from a modem to the network in two-wire (or a wire pair) topology.

When the data is transmitted from the network to the PC (or alike), the data is received in the hybrid circuit 406, which converts the two-wire topology into the four-wire topology, and thereafter transfers the data to an analog anti-alias filter 407, which suppresses incoming frequency components above half of the analog to digital (A/D) sampling frequency that would otherwise result in the well known aliasing phenomenon.

An analog AGC (Automatic Gain Control) circuit 408 receives the data from the analog anti-alias filter 407, and adjusts the dynamic range of the incoming signal such that the quantization resolution of an A/D converter 409 is sufficient. After the incoming signal is adjusted, the data is transferred to the A/D converter that converts the signal from the analog form into the digital form.

From the A/D converter, the signal is transferred to a digital AGC (Automatic Gain Control) circuit 410, which adjusts the digital signal level according to the control signal from the modem circuit. The digital AGC circuit 410 is located within the signal processing unit of the system. The incoming data is filtered digitally according to the same profile, which is chosen in the far-end transmitter. Thereafter, the data is transferred to the modem chip 401, which further provides the digital data to a processing system of the PC through one or more busses.

In the preferred embodiment of the present invention, it is possible to configure the digital filters in the signal processing unit by modem control software. The tunability property of the digital filters can be accomplished by using e.g., polynomial filter coefficient interpolation (that is well known to the man skilled in the art) or by uploading tables of filters onto the signal processing unit chip through a controlling host. The polynomial filter coefficient interpolation may be achieved by using a Farrow structure for interpolation.

The transmission profiles can be updated using NEM and Secure Shell (SSH) connection. The connection is established to the remote modem (whether DSLAM in CO or CPE) using NEM and Hyper Text Transfer Protocol (HTTP). The remote modem is notified to download a new profile configuration file or a modem control software from certain host. Remote modem acts as a client and requests the new profile configuration file or the modem control software from user-determined server. The modem control means changes profile parameters or reads the new parameters from a configuration file.

The new parameters that are received from a specified host may be loaded to the memory of the customer premises equipment, wherefrom the parameters may be loaded to the digital filters of the signal processing unit of the DSL modem of the customer premises equipment. There may also be new parameters to the modem chip of the DSL modem in the received new configuration file or the modem control software that may be processed so that the modem control means transmits new or modified parameters to the modem chip essentially at the same time than the modem control means transmits the new or modified parameters to the signal processing unit of the DSL modem.

The measuring of the characteristics of the connection between the remote modem and DSLAM (or alike), that is done preceding the change or modification of the parameters in the remote modem, may be done in different ways. For example, the Network Element Manager (NEM) may measure the connection, and send the notification to download the new configuration file or the modem control software, to the remote modem.

Alternatively, the remote modem may measure the connection between the remote modem and the DSLAM (or alike) itself, and make an iteration of the parameters of the remote modem. In the alternative solution, the remote modem configures the parameters of the remote modem itself without requesting to download the new configuration file or the modem control software from a specified host e.g., in the network.

The remote modem may also request to download the new configuration file or the modem control software from the specified host (after measuring that the remote modem and the DSLAM modem uses different parameters in the connection), if the specified hosts are defined e.g., in the modem control means of the modem, or the host is specified via the Network Element Manager.

The digital filters comprise in general a chain of delay elements and gain elements. The delay and gain elements may also be looped back and have multiple branches. The signal that is filtered passes through these elements. By changing the values of the elements (gains and delay times), also called coefficients, the filters transfer characteristics can be changed. By choosing properly the parameter values cut-off frequencies can be adjusted. The remote tunability bases whether on 1) transferring a table to the remote modem including the new parameters or on 2) transferring new control software which manipulates the filter coefficients in means of polynomial coefficient interpolation. The new configuration is designed beforehand, and later on new configurations can be designed on request.

The preferred embodiment of the present invention further enables that all transmission profile filtering can be done in the signal processing unit (i.e., in the FPGA chip or in the ASIC chip). This further enables that the consume of the circuit board space in the modem chip can be decreased when compared to the prior art implementations. Further, the preferred embodiment of the present invention enables that modem control software can be used to configure the digital filters in the signal processing unit circuitry in remote mode.

The VDSL modem disclosed with reference to FIG. 4, may be a separate modem for individual user or it may be a modem card in a PC (or in a set-top-box of a television or in a television in the future) or in a DSLAM.

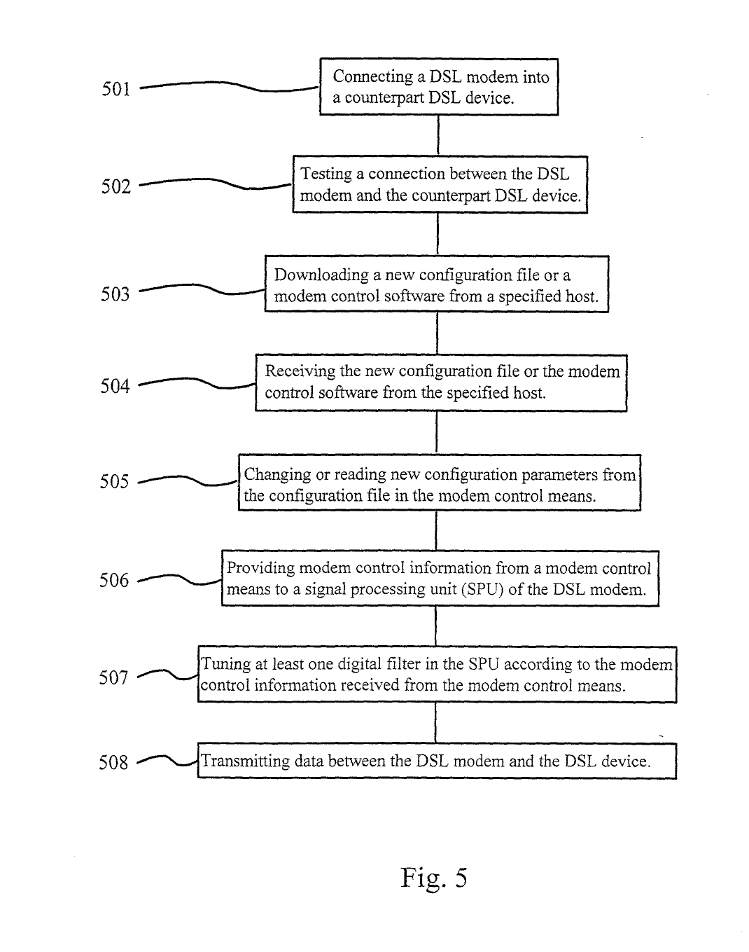

FIG. 5 is a flowchart illustrating the method of the preferred embodiment of the present invention. In step 501, the connection between a DSL modem and a counterpart DSL device is established. The connection is established between a customer premises DSL modem and a DSL device in the network (e.g., a DSLAM).

After connecting the DSL modem and DSL device, the connection is tested (step 502). In case the connection between the DSL modem and the DSL device is functioning properly, i.e., the DSL modem can connect to the DSL device, the DSL modem receives a notification to download a new configuration file or a modem control software from a specified host (i.e., a user defined server, which may be a remote host defined by the DSL device).

Thereafter, the new configuration file or the modem control software is requested and downloaded to modem control means from the specified host (step 503).

After receiving the new configuration file or the modem control software from the specified host (which may also be the counterpart DSL modem) (step 504), the modem control means changes or reads new configuration parameters from the configuration file or the modem control software, i.e., the parameters of the DSL modem are reconfigured in the modem control means of the DSL modem (step 505). The changing of parameters may be implemented in the modem control means by interpolation or by changing the configuration parameters into configuration parameters according to a specified plan. The specified plan can be e.g., plan 997 for symmetric and asymmetric capabilities frequency band allocation, plan 998 for asymmetric capabilities frequency band allocation, or some proprietary allocation. The changed or modified parameters may be loaded to a memory of the customer premises equipment.

In step 506, the modem control means provides (or transmits) the modem control information, i.e., reconfigured parameters, to a signal processing unit (SPU) of the DSL modem via a bus or a line. The modem control means can provide modem control information to the signal processing unit and to the modem circuit (or a chip) essentially at the same time. The modem control information that is provided whether from the modem control means or from the memory to the signal processing unit and to the modem chip comprises changed or modified parameters.

After providing the modem control information to the signal processing unit, at least one transmit and one receive digital filter is tuned (or adjusted) in the signal processing unit according to the modem control information (step 507). In step 508, the system is capable of transmitting data between the DSL modem and the DSL device optimally, since the digital filters of the DSL modem and the DSL device are modified to the corresponding states.

The reasons for adjusting (or tuning) the digital filters may be that the physical characters of the subscriber line has been changed or the DSL modem has been taken into use in an area that does not correspond to the area whereto the DSL modem was tuned in the factory. There may also be some in-band disturbances in the connection between the DSL modem and the DSL device that may require the tuning of the digital filters in the signal processing unit of the DSL modem.

It will be appreciated by the skilled person in the art that various modifications may be made to the above-described embodiments without departing from the scope of the present invention, as disclosed in the appended claims. For example, the measuring point (i.e., where the measuring of the connection between two DSL modems are made) may be in the customer premises equipment or in the Network Element Manager or in some other point that is capable to measure the connection between two DSL modems. Further, the equipment wherein the DSL modems are used may be different from the equipment disclosed herein, as long as they function as disclosed in the appended claims.

1. A signal processing unit in a DSL (Digital Subscriber Line) modem, comprising:
at least one transmit and one receive digital filter that are adjustable through modem control means;
input means for receiving a data from a modem chip;
output means for transmitting data to the modem chip; and
means for providing control parameters to at least one transmit and one receive digital filter from the modem control means.

2. A signal processing unit according to claim 1, wherein the control parameters are provided via a bus from the modem control means to at least one transmit and one receive digital filter.

3. A signal processing unit according to claim 1 or 2, wherein the signal processing unit is arranged to receive control parameters provided by the modem control means, which is a personal computer (PC) or a network element manager (NEM).

4. A signal processing unit according to claim 1 or 2, wherein the signal processing unit further comprises a digital to analog converter for converting a digital data into an analog data and an analog to digital converter for converting an analog data into a digital data.

5. A signal processing unit according to any one of the preceding claims, wherein the signal processing unit further comprises means for adjusting a digital signal level.

6. A signal processing unit according to claim 5, wherein the means for adjusting a digital signal level is an automatic gain control (AGC) circuit.

7. A method for adjusting digital filters of a signal processing unit in a DSL (Digital Subscriber Line) modem, comprising steps of:
connecting a DSL modem into a counterpart DSL device;
testing a connection between the DSL modem and the counterpart DSL device;
providing modem control information from modem control means to the signal processing unit of the DSL modem; and
tuning at least one transmit and one receive digital filter in the signal processing unit of the DSL modem according to the modem control information received from the modem control means.

8. A method according to claim 7, wherein modem control information is provided through a bus connecting the signal processing unit of the DSL modem and the modem control means.

9. A method according to claim 7 or 8, wherein the modem control information is a standard bandplan for VDSL modems, wherein the standard bandplan is one of the following: Plan 997 for symmetric and asymmetric capabilities frequency band allocation, Plan 998 for asymmetric capabilities frequency band allocation.

10. A method according to any one of claims 7 to 9 and further comprising a step of downloading a new configuration file or a modem control software from a specified host upon notification.

11. A method according to any one of claims 7 to 10 and further comprising a step of receiving in the modem control means a new configuration file or a modem control software from a specified host.

12. A method according to any one of claims 7 to 11 and further comprising a step of changing new configuration parameters or reading new configuration parameters from a configuration file in the modem control means.

13. A method according to any one of claims 7 to 12 and further comprising a step of providing from the modem control means the configuration parameters, i.e., the modem control information, to digital filters in the signal processing unit of the DSL modem.

14. A method according to claim 12 or 13, wherein the configuration parameters can be changed in the modem control means by coefficient interpolation method or by changing the configuration parameters into configuration parameters according to a specified plan.

15. A method according to any one of claims 7 to 14, wherein the modem control means transmit configuration information to both digital filters and a modem chip essentially at the same time.

16. A method according to any one of claims 7 to 15, wherein the configuring information is changed according to the change in physical characteristics of the subscriber line.

17. A DSL (Digital Subscriber Line) modem for data receiving and transmitting, comprising:
signal processing unit having at least one transmit and one receive digital filter that are adjustable through modem control means, input means for receiving a data from a modem chip, output means for transmitting data to the modem chip, and means for providing control parameters to at least one transmit and one receive digital filter from the modem control means;
a digital to analog converter for converting a digital data into an analog data;
an analog to digital converter for converting an analog data into a digital data;
a modem circuit, which is configurable through the modem control means;
an analog anti-image filter for adjusting maximum frequency of the outgoing signal;
an analog anti-alias filter for adjusting maximum frequency of the incoming signal; and
a circuitry for transforming between two-line and four-line topologies.

18. A DSL modem according to claim 17, wherein the DSL modem is connected to the modem control means through a bus or a cable.

19. A DSL modem according to claim 17 or 18, wherein the modem control means is a personal computer (PC) or a network element manager (NEM).

20. A DSL modem according to any one of claims 17 to 19, wherein the DSL modem further comprises means for adjusting a signal level, wherein the means for adjusting the signal level is an automatic gain control (AGC) circuit.

21. A DSL modem according to any one of claims 17 to 20, wherein the signal processing unit is a FPGA (Field Programmable Gate Array) chip or an ASIC (Application Specific Integrated Circuit) chip.

21. An apparatus comprising multiple DSL (Digital Subscriber Line) modems, the apparatus comprising:
multiple DSL modems, wherein a DSL modem has at least one signal processing unit having at least one transmit and one receive digital filter that are adjustable through modem control means, input means for receiving a data from a modem chip, output means for transmitting data to the modem chip, and means for providing control parameters to at least one transmit and one receive digital filter from the modem control means, the DSL modem further having a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies;
a memory; and
a central processing unit (CPU).

22. A method for data transmission between a customer premises DSL (Digital Subscriber Line) modem and a DSL device, the method comprising:
connecting the customer premises DSL modem to the DSL device through a subscriber line;
receiving a configuration file or a modem control software from a user defined server to a modem control means of the customer premises DSL modem;
reconfiguring the parameters of the customer premises DSL modem in the modem control means;
transmitting the reconfigured parameters of the customer premises DSL modem from the modem control means through a bus or a line to a signal processing unit of the customer premises DSL modem;
tuning digital filters in the signal processing unit of the customer premises DSL modem according to the parameters reconfigured in the modem control means; and
transmitting data between the customer premises DSL modem and the DSL device.

23. A method according to claim 22, wherein the user defined server is a remote host defined by the DSL device.

24. A method according to any one of claims 22 to 23, wherein the method further comprises requesting to download the new configuration file or a modem control software.

25. A system for data transmission between a customer premises DSL (Digital Subscriber Line) modem and a DSL device, the system comprising:
a customer premises DSL modem having signal processing unit having at least one transmit and one receive digital filter that are adjustable through modem control means, input means for receiving a data from a modem chip, output means for transmitting data to the modem chip, and means for providing control parameters to at least one transmit and one receive digital filter from the modem control means, a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies;
a customer premises DSL modem control means for reconfiguring parameters of the customer premises DSL modem;
a subscriber line between the customer premises DSL modem and the DSL device for data transmission;
a DSL device, the DSL device having signal processing unit having at least one transmit and one receive digital filter that is adjustable through modem control means, input means for receiving a data from a modem chip, output means for transmitting data to the modem chip, and means for providing control parameters to at least one transmit and one receive digital filter from the modem control means, a digital to analog converter for converting a digital data into an analog data, an analog to digital converter for converting an analog data into a digital data, a modem circuit, which is configurable through the modem control means, an analog anti-image filter for adjusting maximum frequency of the outgoing signal, an analog anti-alias filter for adjusting maximum frequency of the incoming signal and a circuitry for transforming between two-line and four-line topologies; and
a modem control means of the DSL device for reconfiguring parameters of the DSL device.

26. A system according to claim 25, wherein the system further comprises a remote host, from where the customer premises DSL modem control means requests and downloads a new configuration file or a modem control software in order to reconfigure parameters of the customer premises DSL modem.

27. Means for adjusting digital filters in a DSL (Digital Subscriber Line) modem, the means for adjusting comprising:
means for receiving a configuration file or a modem control software from a host in a network;
means for reconfiguring parameters of a DSL modem; and
means for transmitting the reconfigured parameters to a signal processing unit of the VDSL modem.

28. Means for adjusting according to claim 27, wherein means for receiving request to download the configuration file or the modem control software from a remote host upon notification.

29. A method for adjusting digital filters in a DSL (Digital Subscriber Line) modem, the method comprising:
receiving a configuration file or a modem control software conforming parameters of a counterpart DSL modem in modem control means of the DSL modem;
reconfiguring parameters of the DSL modem in the modem control means;
transmitting the reconfigured parameters to a signal processing unit of the DSL modem; and
tuning digital filters in the signal processing unit of the DSL modem.

30. A method according to claim 29, wherein the method further comprises requesting to download the new configuration file or a modem control software upon notification.
